(19) United States
(12) Patent Application Publication
(10) Pub. No.: US 2026/0007570 A1
(43) Pub. Date: Jan. 8, 2026

(54) TRIGGER POINT MASSAGE TOOL

(71) Applicant: David Barouche, Miami, FL (US)

(72) Inventor: David Barouche, Miami, FL (US)

(21) Appl. No.: 19/134,602

(22) PCT Filed: Jun. 11, 2024
(86) PCT No.: PCT/US2024/033388

§ 371 Date: May 30, 2025

(51) Int. Cl. A61H 39/04

(52) U.S. Cl. CPC A61H 39/04; A61H 2201/0153; A61H 2201/1685; A61H 2201/1695

(57) ABSTRACT

A trigger point massage tool configured to apply ischemic compression to a user's body and that includes a handle member formed in an arcuate shape forming a convex outer surface and a concave inner surface opposing the convex outer surface, having a proximal end, a distal end opposing the proximal end and having a flexible and friction-inducing material disposed thereon, a handle member length separating the proximal and distal ends of the handle member and that includes a trigger point member coupled to the concave inner surface along the handle member length, projecting in a direction away from the concave inner surface to an apex forming a terminal contact surface, and defining a trigger point member diameter tapering toward the terminal contact surface, the apex spaced apart from the distal end of the handle member.

### FIELD OF THE INVENTION

The present invention relates generally to massage tools and, more particularly, relates to a device that can be handheld and is operably configured to provide ischemic compression of myofascial trigger points.

### BACKGROUND OF THE INVENTION

It is well known that the human body experiences myofascial trigger points, or “trigger points.” Trigger points are hyperirritable spots in the skeletal muscle and are associated with palpable nodules in taut bands of muscle fibers. Many users experience discomfort and pain associated with trigger points and desire to alleviate or attenuate said discomfort or pain. One exemplary recognized method to alleviate or attenuate musculoskeletal pain and discomfort is to provide ischemic compression, which, generally, is a manual and/or mechanical treatment of trigger points by applying sustained pressure for a long enough time to inactivate the trigger point and/or cause resurgence of blood flow and lymphatic circulation to the effective area.

In many cases, a user has to see a medical professional to apply ischemic compression in an effective and safe manner. This can be time consuming and costly for many users. To that end, many users attempt to provide therapy to a trigger point with a device, generally having a tapered end. These known devices are problematic for many reasons. These devices do not enable users to effectively, efficiently, or safely reach all parts of a user's body, particularly the user's back. Additionally, many of these known devices are not handheld, cumbersome, and/or require the user to place the device on a flat floor surface, requiring the user to lay down and potentially apply an excessive and unsafe amount of pressure to the trigger point. Furthermore, many of these known devices do not enable the user to apply selectively controlled and effective amounts of pressure to the affected area. For example, one known device is in the shape of an S and requires one arm of the user to be relaxed while the other arm actively holds/pulls the handle of the device to apply pressure to the affected area. The pressure generated by this type of device is from active tension in the user, which is often not sufficient to treat the trigger point effectively and generally can only be applied in limited orientations on the trigger point.

For these known devices, the user will pull the device onto the body with the force generated by the user's active muscles and therefore trying to achieve ischemic compression in an active tense body condition which is self-defeating when trying to alleviate passive trigger points. Said another way, these known devices require the user to pull or push themselves onto the device, putting the treatment trigger points into an active/tense state which makes it difficult to achieve ischemic compression. The push or pull methods require an impossible amount of physical strength from some users and is impractical.

Therefore, a need exists to overcome the problems with the prior art as discussed above.

### SUMMARY OF THE INVENTION

The invention provides a trigger point massage tool that overcomes the hereinafore-mentioned disadvantages of the heretofore-known devices and methods of this general type and that can be manipulated and applied by a user (i.e., massaged) to trigger points of the user's body in a safe, effective, and efficient manner not accomplished by known device and in a selective fashion. Said differently, the present invention utilizes a 2^{nd} class mechanical lever configuration to apply maximal ischemic compression through a “rotational” force at the treatment head via contact of the distal end of the handle member of the device, i.e., the fulcrum, with a wall or other fixed surface. The forces generated with the handle member are done with minimal work on the lever arm, via the fulcrum or nose of the handle member on a fixed surface, such a wall, couch, or bed. This allows for a maximal rotatory compression moment, rather than a linear pulling, or pushing force on a user's passive, relaxed, supine body position.

With the foregoing and other objects in view, there is provided, in accordance with the invention, a trigger point massage tool that includes a handle member formed in an arcuate shape forming a convex outer surface and a concave inner surface opposing the convex outer surface, having a proximal end, a distal end opposing the proximal end and having a flexible and friction-inducing material disposed thereon, and a handle member length separating the proximal and distal ends of the handle member. Additionally, the tool includes a trigger point member coupled to the concave inner surface along the handle member length, projecting in a direction away from the concave inner surface to an apex forming a terminal contact surface, and defines a trigger point member diameter tapering toward the terminal contact surface, wherein the apex spaced apart from the distal end of the handle member.

In accordance with a further feature of the present invention, the handle member is made of a substantially rigid material operably configured to flex.

In accordance with an additional feature of the present invention, the trigger point member diameter continuously tapers to the terminal contact surface and may be formed in a pyramidal shape.

In accordance with an exemplary feature of the present invention, the terminal contact surface is dull and the apex of the trigger point member is a height less than approximately 20 cm and spaced apart from the distal end of the handle member a length ranging from 5-20 cm.

In accordance with another feature, an embodiment of the present invention includes the handle member includes a nose member extending a nose length away from the trigger point member towards the distal end and defining a nose width separating two opposing sides of the nose member, wherein the flexible and friction-inducing material spans the nose width.

In accordance with another feature of the present invention, the nose member is of a substantially rigid material operably configured to flex.

In accordance with yet another feature of the present invention, the flexible and friction-inducing material encloses the nose member along the nose length and is disposed on a nose top surface and a nose bottom surface opposing the nose top surface.

In accordance with another feature, an embodiment of the present invention also includes the handle member having a grasping portion spanning from the proximal end along the handle member length a grasping distance of at least 10 cm and defining a grasping portion diameter spanning the grasping distance that is less than the nose width.

In accordance with an additional feature of the present invention, the nose width ranges from 5-16 cm and the flexible and friction-inducing material spans from the distal end of the handle member toward the proximal end of the handle member and under a nose bottom surface of the nose member.

In accordance with an exemplary feature of the present invention, the flexible and friction-inducing material is made of a polymeric material.

In accordance with a further feature of the present invention, the trigger point member is selectively and freely uncouplable to the concave inner surface, e.g., the trigger point member is selectively and freely uncouplable to the concave inner surface in a male-female and friction-fit configuration.

Also in accordance with the present invention, a trigger point massage tool is disclosed that includes a handle member with a convex outer surface, with a concave inner surface opposing the convex outer surface, having a proximal end, a distal end opposing the proximal end and having a flexible and friction-inducing material disposed thereon, a handle member length separating the proximal and distal ends, and with a nose member disposed proximal to the distal end and defining a nose width separating two opposing sides of the nose member, wherein the flexible and friction-inducing material spans the nose width and also having a trigger point member interposed between the nose member and the proximal end of the handle member, coupled to the concave inner surface along the handle member length, projecting in a direction away from the concave inner surface to an apex forming a terminal contact surface and spaced apart from the distal end of the handle member, and defining a trigger point member diameter tapering toward the terminal contact surface.

In accordance with yet another feature of the present invention, the handle member forms an arcuate shape and the nose member extends a nose length away from the trigger point member towards the distal end.

Although the invention is illustrated and described herein as embodied in a trigger point massage tool, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the handle of the trigger point massage tool. As used herein, the term “wall” is intended broadly to encompass continuous structures, as well as, separate structures that are coupled together so as to form a substantially continuous external surface.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a trigger point massage tool coupled to a resting support member in accordance with one embodiment of the present invention;

FIG. 2 is a perspective view of the trigger point massage tool in FIG. 1 utilized with a wall surface in accordance with one embodiment of the present invention;

FIG. 3 is an elevational side view of the trigger point massage tool in FIG. 1 in accordance with one embodiment of the present invention;

FIG. 4 is an overhead perspective view of the trigger point massage tool in FIG. 1 in accordance with one embodiment of the present invention;

FIG. 5 is an underneath perspective view of the trigger point massage tool in FIG. 1 in accordance with one embodiment of the present invention;

FIG. 6 is another perspective view of the trigger point massage tool in FIG. 1 in accordance with one embodiment of the present invention;

FIG. 7 is a close-up left-side view of section area 7-7 in FIG. 6 in accordance with one embodiment of the present invention;

FIG. 8 is a close-up right-side view of section area in FIG. 7;

FIG. 9 is a perspective view of the resting support member in FIG. 1 in accordance with one embodiment of the present invention;

FIG. 10 is a perspective view of a trigger point massage tool, selectively couplable trigger point members, and floor supports in accordance with one embodiment of the present invention;

FIG. 11 is a perspective fragmentary view of a trigger point massage tool in accordance with one embodiment of the present invention;

FIG. 12 is a perspective view of a trigger point massage tool with an elongated nose member and a resting support member with a hook member inserted into a hook aperture of the trigger point massage tool in accordance with one embodiment of the present invention;

FIG. 13 is a perspective fragmentary view of a trigger point massage tool with a hook aperture in accordance with one embodiment of the present invention;

FIG. 14 is a close-up view of the trigger point massage tool in FIG. 13 with a hook member of a handle support member attached to a wall surface and the hook member disposed within the hook aperture to retain the handle member of the trigger point massage thereon in accordance with one embodiment of the present invention;

FIG. 15 is a perspective view of a trigger point massage tool coupled to a resting support member in accordance with one embodiment of the present invention; and

FIGS. 16-21 are perspective views of a trigger point massage tool utilized in various positions against contact and support surfaces.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

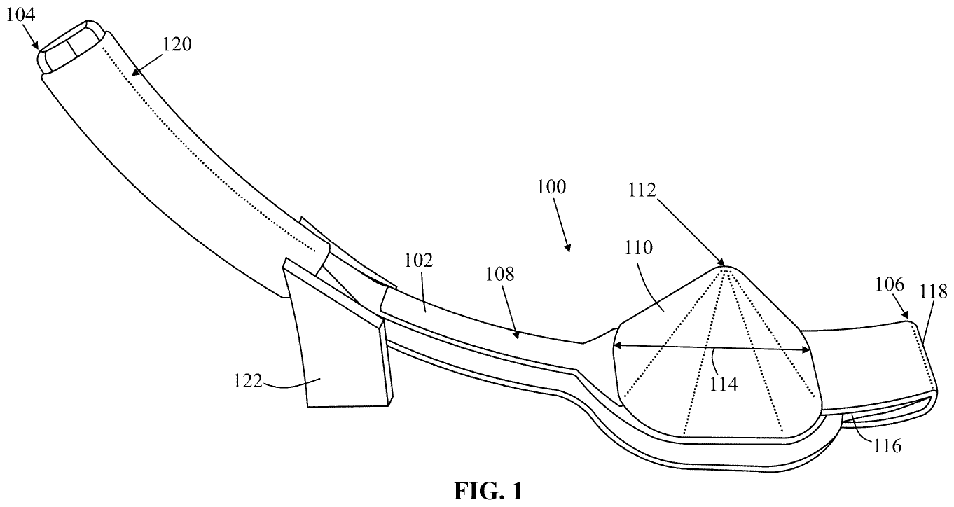

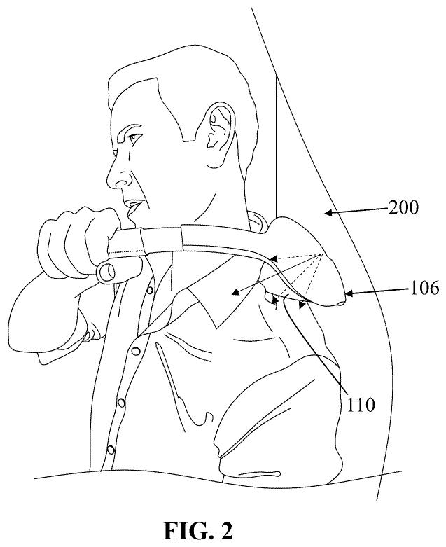

The present invention provides a novel and efficient trigger point massage tool that provides user effective, safe, and efficient therapy of trigger points by utilize a wall surface or other similar surface. More specifically, and referring now to FIGS. 1-2, one embodiment of the present invention is shown in perspective views. FIGS. 1-2 show several advantageous features of the present invention, but, as will be described below, the invention can be provided in several shapes, sizes, combinations of features and components, and varying numbers and functions of the components. The first example of a trigger point massage tool 100 includes a handle member 102 with a friction-inducing material 118 disposed on a distal end 106 thereof for contacting a wall surface 200 or other similar surface and a trigger point member 110 coupled to the handle member 102 for apply pressure to the trigger point of the user. As such, the user can apply ischemic compression or otherwise treat a trigger point with a single hand. Also importantly, the massage tool 100 utilizes the wall or other surface as a fulcrum for which to apply a selectable and directional amount of force (represented with arrows in FIG. 2) to the trigger point or other effected and desired area of the user's body.

To effectuate the same, the handle member 102 may be formed in an arcuate shape with a substantially rigid, yet flexible, material such as a polymeric material or aluminum material. The material should be a sufficient rigidity to maintain its static shape without any external force (other than gravity) and not plastically deform or fail when applying forces of approximately 40 lbf on the handle member 102 when the distal end 106 is containing the wall surface 200 and the trigger point member 110 is contacting the user. Said differently, exemplary materials may include a thermoplastic polyester or polymer such as polycarbonates or ABS plastic having a tensile strength ranging from 30-150 MPa and a Youngs modulus ranging from 0.5-8 GPa. The handle member 102 is configured to flex slightly when applying a force on the handle member 102 proximal to the proximal end 104 (as exemplified din FIG. 2) and when placed on the wall and user.

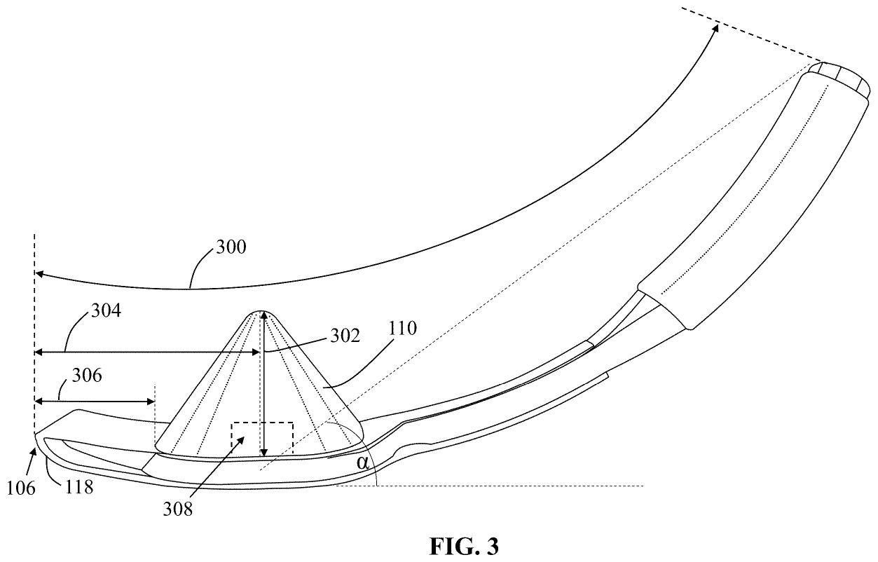

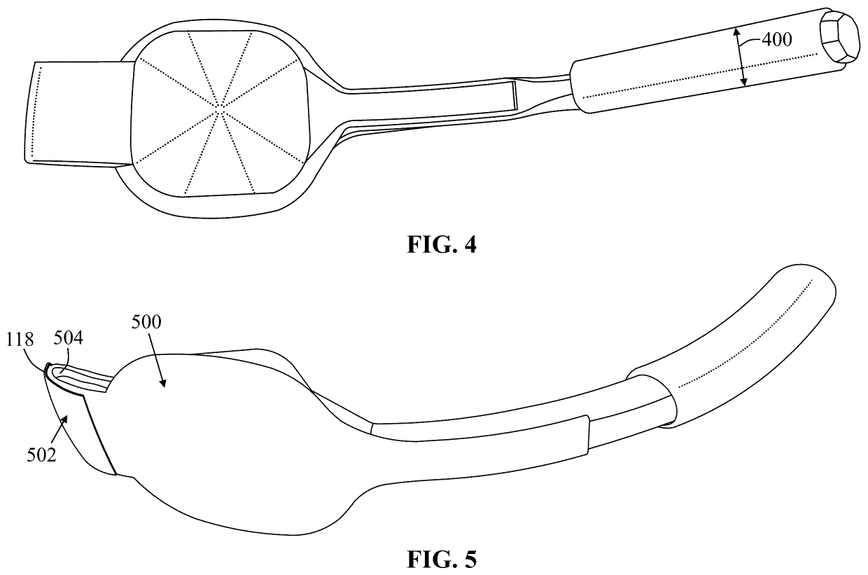

In one embodiment, also with reference to FIGS. 3-5, the handle member 102 may be pre-formed into the arcuate shape, i.e., its static state shape, to create the necessary shape to safely and effectively reach a wall surface and have the trigger point member 110 contact a user's body and generate a greater amount of pressure on the user. The handle member 102 may include a convex outer surface 500 and a concave inner surface 108 opposing the convex outer surface 500 and includes a proximal end 104 and a distal end 106 opposing the proximal end 104, wherein the distal end 106 includes the flexible, deformable, and friction-inducing material 118 disposed thereon for contacting the wall surface 200 without damaging the same (e.g., leaving scuffs, holes, etc.). This flexible, deformable, and friction-inducing material 118 has a contacting surface 502 (best seen in FIG. 5) and is of a material different than material of handle member 102. As such, the flexible, deformable, and friction-inducing material 118 that forms the contacting surface prevents or inhibits the handle member 102 from slipping off of the wall surface and can slightly bend or deform to allow the handle member 102 to apply forces and pressures in alternative orientations and directions (exemplified in FIG. 2) without necessarily removing the handle member 102 from the wall surface 200. For example, one benefit of the invention is that the configuration of the handle member 102 and the distal end 106 enable the user to apply pressure, rotational torque, and enhanced compression on the user's body via the mechanical advantage and lever arm and with out removing the handle member 102 from the wall or other contacting fixed surface.

The handle member 102 has a handle member length 300 separating the proximal and distal ends 104, 106 and may be approximately 15-45 cm, or 6-18 inches. The handle member 102 preferably has a grasping portion 120 spanning from the proximal end 104 along the handle member length 300 a grasping distance of at least 10 cm (4 in). The grasping portion 120 may include a rubber, elastomeric, deformable, and friction-inducing grip enabling the user to hold onto the handle member 102 and apply pressure via the wall surface 200 while reducing the likelihood of the user's hand slipping from the handle member 102 (particularly when wet or sweating). The grasping portion 120 defines a grasping portion diameter 400 that may span the grasping distance.

The trigger point member 110 can be seen coupled to the concave inner surface 108 along the handle member length 300, projecting in a direction away from the concave inner surface 108 to an apex forming a terminal contact surface 112, and defining a trigger point member diameter 114 tapering toward the terminal contact surface 112. The apex of the trigger point member 110 is spaced apart, longitudinally, from the distal end 106 of the handle member 102 a length 304 to enable the end of the handle member 102 to contact the wall or other surface and the apex to contact the user. The terminal contact surface 112 may be opposite a base of the trigger point member 110 that couples to the concave inner surface 108.

In one embodiment, the trigger point member diameter 114 continuously tapers to the terminal contact surface 112 or otherwise forms a singular tip for applying pressure to the user. Additionally, the trigger point member 110 may be beneficially formed in a pyramidal shape, as depicted in the figures. Said another way, the trigger point member 110 may be triangular, square, conical, a tetrahedron shape, or even spherical shapes, but would not include cubical or, cylindrical shapes. The term may also include other three-dimensional shapes with side or lateral faces or surfaces that extend vertically away from the concave surface 108 in a converging manner. In preferred embodiments, the contact surface 112 is dull, i.e., lacking sharpness, e.g., rounded, flat, or otherwise configured such as to not penetrate a user's skin with 20 lbs of force or less.

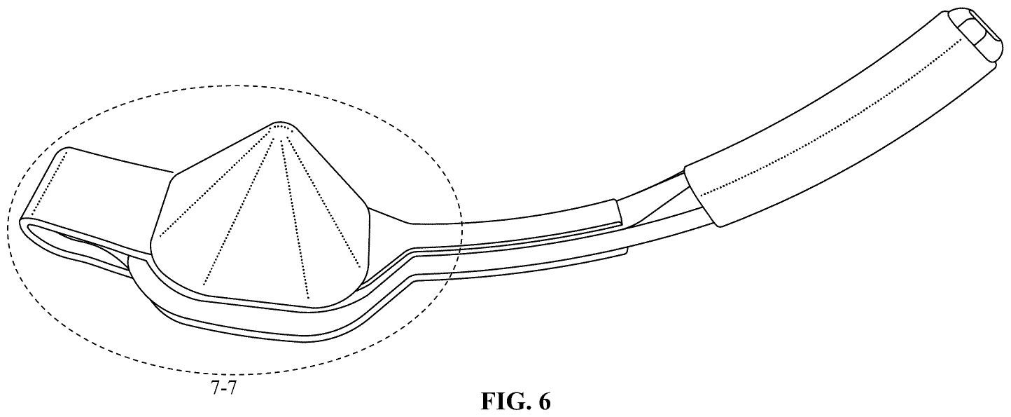

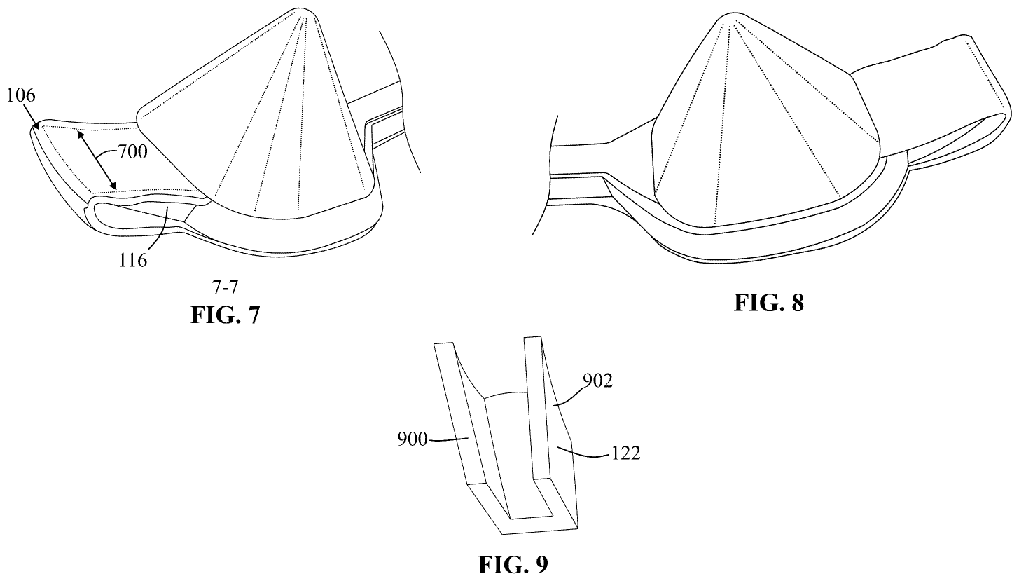

Referring to FIGS. 1-3, the apex of the trigger point member 110 is a height 302 less than approximately 20 cm, e.g., 12-15 cm, and spaced apart from the distal end 106 of the handle member 102 a length 304 ranging from 5-20 cm, e.g., preferably around 10 cm. The advances height 302 of the trigger point member 110 enables the user to effectuate trigger point therapy comfortably and efficiently. Also, with reference to FIG. 4 and FIG. 7, the handle member 102 also includes a nose member 116, which is a structure that may form part of the handle member 102 or be attached to the handle member 102. The nose member 116 provides compressive, tensile, and torsion support for the handle member 102 when placed up against the wall surface 200. The nose member 116 extends the nose length 306, e.g., 10-15 cm (4-6 inches), away from the trigger point member 110 towards the distal end 106 and also defines a nose width 700 separating two opposing sides of the nose member 116. As seen in the figures, the flexible and friction-inducing material spans at least the nose width 700, but may preferably extend past the two opposing sides of the nose member 116. To absorb the above-described forces, the handle member 102 and nose member 116 are preferably of the substantially rigid material that is also operably configured to flex. As seen in the figures, the grasping diameter 400 may be less than the nose width 700 so the assembly 100 can be placed against the wall surface 200 and angled or tilted back and forth without removing it from the wall surface 200. To that end, the nose width ranges from 5-16 cm, but preferably approximately 12 cm (or 4 inches).

In one embodiment, the flexible and friction-inducing material encloses the nose member 116 along the nose length 306 and is disposed on a nose top surface and a nose bottom surface opposing the nose top surface (best depicted in FIG. 5 and FIG. 7). The flexible and friction-inducing material may be coupled to the nose member 116 with adhesive or using another semi-permanent coupling method. The flexible and friction-inducing material, namely the contacting surface 502 thereon, preferably spans from the distal end 106 of the handle member 102 toward the proximal end 104 of the handle member 102 and under the nose bottom surface of the nose member 116 (best depicted in FIG. 5). To facilitate in enabling the assembly 100 to grip and stay on the wall surface 200 or other surface during application of the assembly, the flexible and friction-inducing material 118 is preferably made of a polymeric material, e.g., a foam material or a rubber material like nitrile, silicone rubber, ethylene propylene rubber, neoprene. In one embodiment, the nose member 116 includes a deformably resilient material 504 surrounding (partially or completely) it and has the flexible and friction-inducing material 118 coupled thereto. In other embodiments, the deformably resilient material 504 may also be the friction-inducing material 118. The term “deformably resilient” is defined as having a surface or material with the ability to at least change in shape when disposed to forces of a user, e.g., 0.5-2 lbf (i.e., an external force), while then returning to its original shape after the external force is removed.

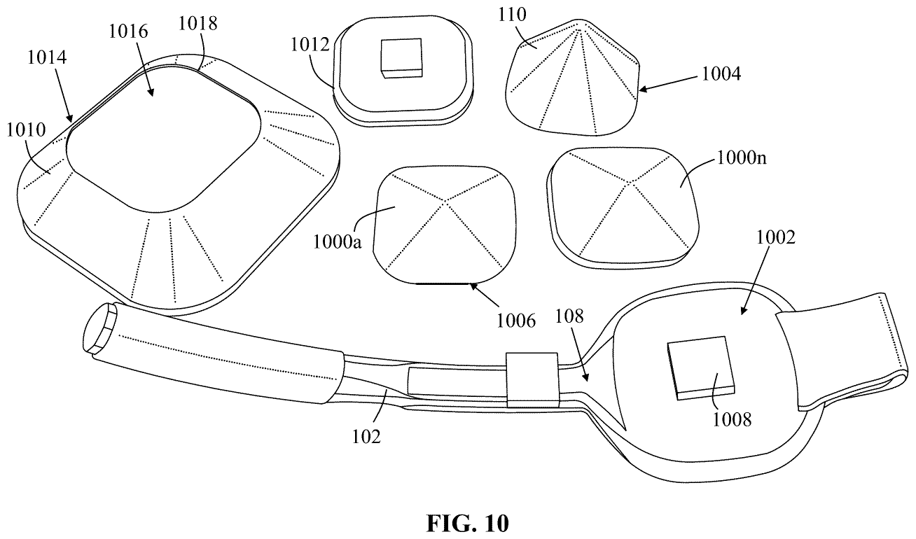

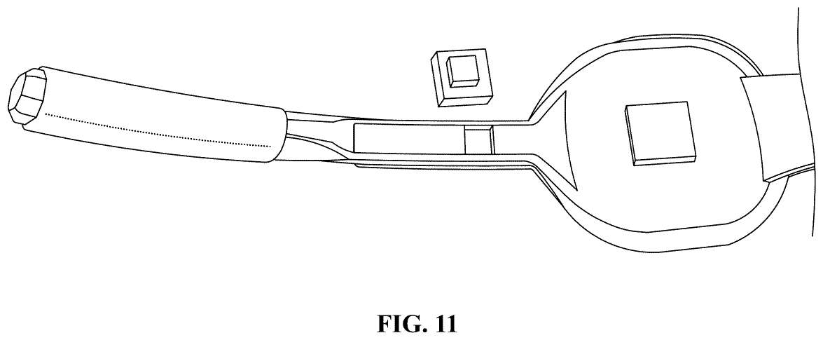

In one beneficial embodiment, the trigger point member 110 is selectively and freely uncouplable to the concave inner surface 108 so that different trigger point members 1000a-n can be coupled thereto, wherein “n” represents any number greater than one. As such, different trigger point members 1000a-n with varying heights and shapes for the terminal contact surface can be utilized by the user (depending on user's desired pressure intensity or body type). Said differently, the trigger point member 110 may be selectively and freely uncouplable to the concave inner surface 108 in a male-female and friction-fit configuration. More specifically, the handle member 102 may define a trigger point platform portion 1002 that may be shaped and sized to correspond with the base 1004 of the trigger point member 110 or a base 1006 of another of the trigger point members 1000a-n. With brief reference to FIG. 3 and FIG. 10, each of the trigger point members may define a female recess 308 shaped to correspond with a male attachment member 1008 and may also be of a size (e.g., diameter, length, etc.) approximately equal to the size of the male attachment member 1008 to provide a friction fit. In one embodiment, the friction fit coupling configuration may be effectuated with a rubber gasket on either the female recess 308 and/or the male attachment member 1008. A tongue-and-groove configuration may also be utilized.

In another embodiment of the present invention, the assembly may utilize floor supports 1010, 1012 that have a planar support surface (e.g., 1014) surface and an upper surface (e.g., 1016) for receiving one of the trigger point members 110, 1000a-n. The upper surface 1016 may also include a male-female coupling structure or may include a raised perimeter ridge 1018 configured to horizontally retain the coupled trigger point member, wherein the raised perimeter ridge 1018 may be approximately 1 cm in relative to the upper surface 1016 and may uniformly span the height around the perimeter.

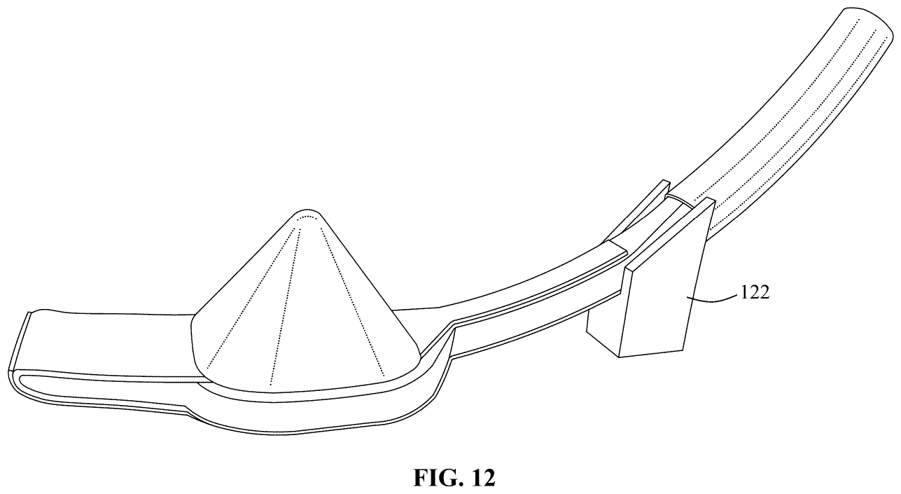

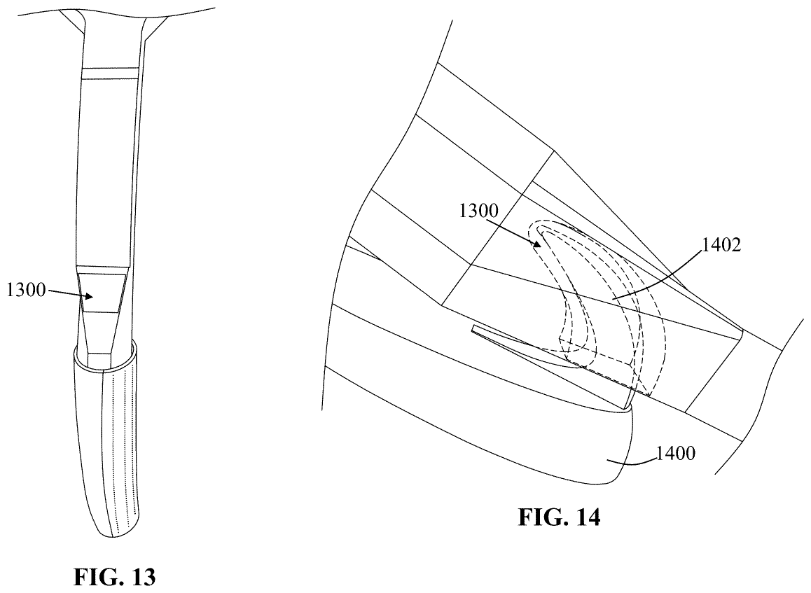

To retain the handle member 102 in a safe, convenient, and effective manner, the assembly may also include handle supports 122, 1400 (as best depicted in FIG. 1, FIG. 9, and FIG. 14, respectively). More specifically, the handle support 122 is a structure that may include two upright members 900, 902 defining a U-shaped channel shaped and sized to receive the handle diameter 400 (preferably in a tight or friction-fit configuration). The handle support 112 enables the handle member 102 to be placed in a storage configuration or, in some embodiments, a use configuration on a flat floor surface. The handle support 1400 is particulate advantageous for wall surfaces (as exemplified in FIG. 14). More specifically, the handle support 1400 is placed in a flat configuration on a wall surface and includes a hook member protruding therefrom. The handle support 1400 may be coupled to the wall surface using an adhesive or other fastener. The hook member is preferably shaped and sized to be received within a hook aperture 1300 (shown best in FIGS. 13-14). The hook aperture 1300 may be shaped and sized to correspond with the hook member and may span toward the proximal end 104 of the handle member 102 and internally within the handle member 102 to ensure little movement of the handle member 102 when attached to the handle support 1400.

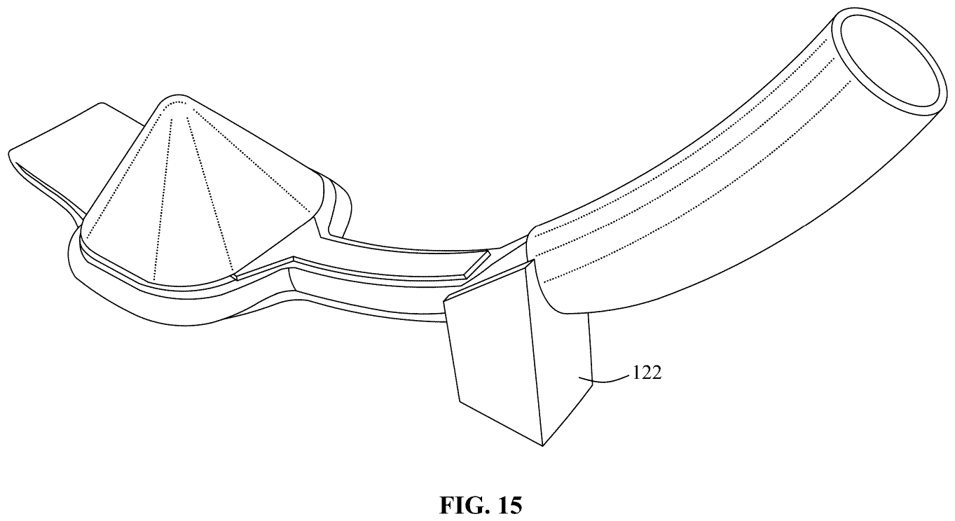

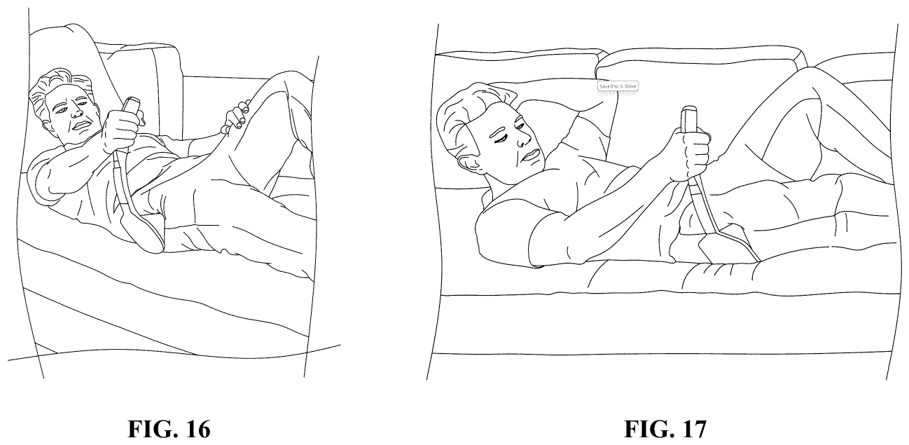

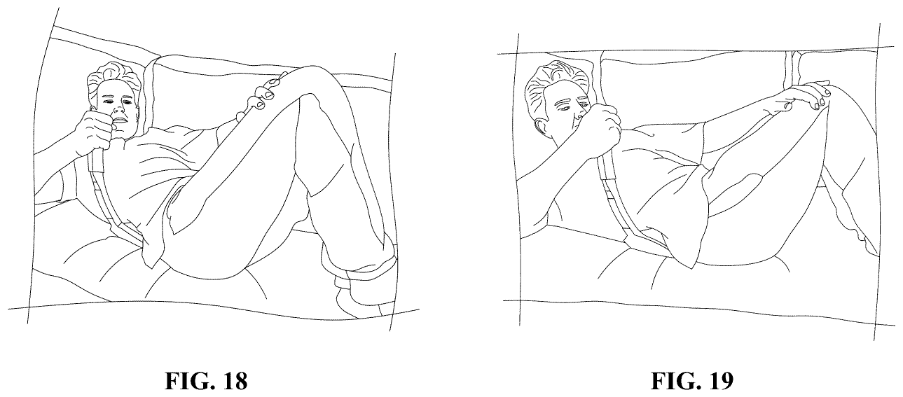

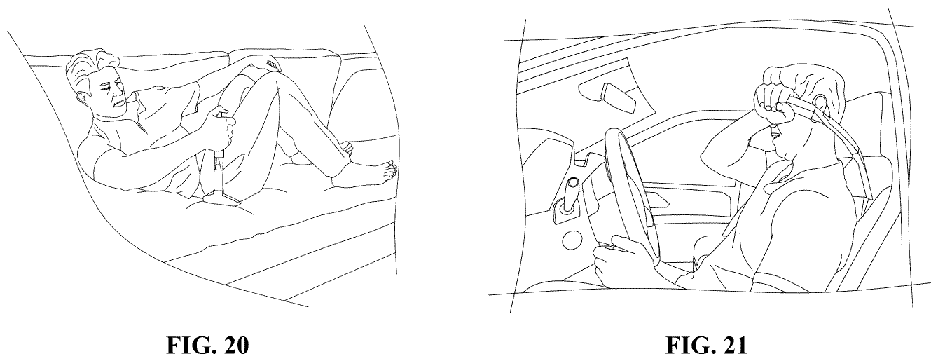

With reference to FIGS. 16-21, a trigger point massage tools can be seen depicted utilized in various positions by a user. Specifically, the trigger point massage tool utilizes the tip or other portion of the handle as a fulcrum for which to apply a selectable and directional amount of force to the trigger point or other effected and desired area of the user's body. To that end, the trigger point massage tool can be utilized on a couch, bed, car, or another surface for applying force.

Therefore, a specific order of executing utilization steps of the assembly 100 has been described and depicted, wherein the order of executing the steps may be changed relative to the order shown in certain embodiments. Also, two or more steps described or shown as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

1. A trigger point massage tool comprising:
a handle member formed in an arcuate shape forming a convex outer surface and a concave inner surface opposing the convex outer surface, having a proximal end, a distal end opposing the proximal end and having a flexible and friction-inducing material disposed thereon, a handle member length separating the proximal and distal ends of the handle member;
a trigger point member coupled to the concave inner surface along the handle member length, projecting in a direction away from the concave inner surface to an apex forming a terminal contact surface, and defining a trigger point member diameter tapering toward the terminal contact surface, the apex spaced apart from the distal end of the handle member; and
a nose member extending a nose length away from the trigger point member towards the distal end of the handle member, having a nose bottom surface, and defining a nose width separating two opposing sides of the nose member, wherein the flexible and friction-inducing material spans the nose width, spans from the distal end of the handle member toward the proximal end of the handle member, and spans under the nose bottom surface.

2. The trigger point massage tool according to claim 1, wherein the handle member is made of a substantially rigid material operably configured to flex.

3. The trigger point massage tool according to claim 1, wherein the trigger point member diameter continuously tapers to the terminal contact surface.

4. The trigger point massage tool according to claim 1, wherein the trigger point member is formed in a pyramidal shape.

5. The trigger point massage tool according to claim 4, wherein the terminal contact surface is dull.

6. The trigger point massage tool according to claim 1, wherein the apex of the trigger point member is a height less than approximately 20 cm and spaced apart from the distal end of the handle member a length ranging from 5-20 cm.

7. (canceled)

8. The trigger point massage tool according to claim 1, wherein the nose member is of a substantially rigid material operably configured to flex.

9. The trigger point massage tool according to claim 1, wherein the flexible and friction-inducing material encloses the nose member along the nose length and is disposed on a nose top surface and a nose bottom surface opposing the nose top surface.

10. The trigger point massage tool according to claim 1, wherein the handle member further comprising:
a grasping portion spanning from the proximal end along the handle member length a grasping distance of at least 10 cm and defining a grasping portion diameter spanning the grasping distance that is less than the nose width.

11. The trigger point massage tool according to claim 1, wherein the nose width ranges from 5-16 cm.

12. (canceled)

13. The trigger point massage tool according to claim 1, wherein the flexible and friction-inducing material is made of a polymeric material.

14. The trigger point massage tool according to claim 1, wherein the trigger point member is selectively and freely uncouplable to the concave inner surface.

15. The trigger point massage tool according to claim 1, wherein the trigger point member is selectively and freely uncouplable to the concave inner surface in a male-female and friction-fit configuration.

16. A trigger point massage tool comprising:
a handle member with a convex outer surface, with a concave inner surface opposing the convex outer surface, having a proximal end, a distal end opposing the proximal end and having a flexible and friction-inducing material disposed thereon, a handle member length separating the proximal and distal ends, and with a nose member disposed proximal to the distal end, having a nose bottom surface, and defining a nose width separating two opposing sides of the nose member, wherein the flexible and friction-inducing material spans the nose width, spans from the distal end of the handle member toward the proximal end of the handle member, and spans under the nose bottom surface; and
a trigger point member interposed between the nose member and the proximal end of the handle member, coupled to the concave inner surface along the handle member length, projecting in a direction away from the concave inner surface to an apex forming a terminal contact surface and spaced apart from the distal end of the handle member, and defining a trigger point member diameter tapering toward the terminal contact surface.

17. The trigger point massage tool according to claim 1, wherein the handle member forms an arcuate shape and the nose member extends a nose length away from the trigger point member towards the distal end.

18. The trigger point massage tool according to claim 16, wherein the terminal contact surface is dull.
